(19) United States
(12) Patent Application Publication
(10) Pub. No.: US 2016/0305065 A1
(43) Pub. Date: Oct. 20, 2016

(54) ROPE REALISED BY WINDING A BAND AS A HANK

(71) Applicants: Fabio BRANCALEONI, Roma (IT); Roberto MARNETTO, Roma (IT); EDIL CAM SISTEMI S.R.L., Roma (IT)

(72) Inventors: Fabio BRANCALEONI, Roma (IT); Roberto MARNETTO, Roma (IT)

(21) Appl. No.: 15/101,345

(22) PCT Filed: Dec. 1, 2014
(86) PCT No.: PCT/IT2014/000321

§ 371 Date: Jun. 2, 2016

(30) Foreign Application Priority Data
Dec. 2, 2013 (IT) RM2013A000663

(51) Int. Cl. D07B 7/16; E01D 19/16; B65H 75/28; F16G 11/04; F16G 11/14; B65H 55/00; D07B 1/18; E01D 19/14

(52) U.S. Cl. CPC D07B 7/165; D07B 1/18; E01D 19/16; E01D 19/14; F16G 11/046; F16G 11/146; B65H 55/00; B65H 75/28; D07B 2401/201; D07B 2401/205; D07B 2501/203

(57) ABSTRACT

The present invention concerns a rope comprised of a band, mainly having a linear extension with flat faces and a substantially flattened straight cross-section, the rope comprising two pins spaced each other along an axis passing between the pins, the band being wound up on the two pins, in such a way to continuously form a plurality of overlapped coils, wherein the plurality of band portions extending parallel to the axis passing between a pin and the other realize two arms and a bending point in correspondence of each pin, the rope comprising at least one clamping device near at least one of the bending points, able to direct, from outside toward inside the rope, each of the arms in at least one counter-bending point in order to block the mutual sliding of the plurality of band portions and the rotation of the rope around at least one of the pins, as a result of a loss of balance of the load applied on the rope.

### CROSS-REFERENCE TO RELATED APPLICATIONS

This application is a National Stage entry of International Application No. PCT/IT2014/000321, filed Dec. 1, 2014, which claims priority to Italian Patent Application No. RM2013A000663, filed Dec. 2, 2013. The disclosures of the prior applications are hereby incorporated in their entirety by reference.

The present invention relates to a rope realised by winding a band as a hank.

More specifically, the present invention relates to a rope comprising a continuous band wound as a hank about two pins, corresponding to the ends for hooking the rope to a structure.

A particular type of rope will be described in the following, realised by composition of portions or tracts of a band, and employed for civil works, such as suspension bridges, but it is to be understood that the present invention can be applied to every type of rope, regardless the material is made up of, and regardless its final use.

Always more difficult challenges in the infrastructure field, with the need of covering always larger span, involve always more daring choices, with all the structural elements required to give the best response, not only strictly as far as static efficiency is concerned, but also maximum guarantee both from the point of view of durability and the less difficulties of installation, since these aspects involve high economic costs.

As it is well known, among known solutions for suspensions systems, and particularly for bridge decks, only two solutions exist, i.e. ropes for composing wires and full section round bars.

Ropes realised by composing steel wires mainly have the following drawbacks:
exposition to corrosion aggression, due to geometric cavities caused by circular section composition, this requiring expensive manufacturing and protection solutions; in fact, presence of empty spaces exposes said elements to direct contact with atmospheric agents that can be particularly aggressive, e.g. when crossing the sea; the above involves either high technological preventive costs and maintenance costs; a solution to this kind of problems provides blowing hot air within ropes, with deriving costs due to the technology and to power consumption;
high deformability under load, characterized by an apparent elastic module much lower than the real one of the material; this means that with the same load, a cable is more deformed, with the bigger differences, than a bar having the same resisting section; this is due to the fact that ropes are realised by twisting wires and said shape causes a “relaxation” under load that is summed to deformation caused by pure lengthening of the material, thus conferring a higher total apparent deformability. This feature is usually considered as negative for proper correction of a suspended structure.
the rope, in its secondary arrangements, besides a single rope, can be a double rope, obtained folding the same rope about the main suspension cable; in correspondence of the folding, the rope is contained within a channel element housing the same along the 180 degrees folding run; in this case, gravitational rope makes wires, particularly in correspondence of the ridge position, permeating each other, thus activating very high local stresses along the contact lines of the cables, that are usually negative for proper global operation and thus jeopardizing their durability.

Instead, suspension bars have the following negative aspects:
due to constructive problems, as well as to handling problems, it is not possible realizing very long elements as a single piece; this aspect involves the needing to nearly always use mechanical joints to obtain the desired length;
higher working costs and higher exposition to corrosion triggering, i.e. needing of particular and expensive shrewdnesses to prevent humidity entering within gaps between said joints, with consequent deterioration;
difficult handling and thus higher assembling costs.

In this context it is included the solution according to the present invention, suggesting overcoming all the above drawbacks, affording a higher technological and installation simplicity, making it extremely convenient either under the structural and economic point of view.

Still another object of the present invention is that of making it convenient the realization of the rope directly in situ, being its components easy to be transported and handled, and their assembling very straightforward.

International patent application WO 2012/011143 A1 described a rope obtained by composing placing side by side a plurality of band having straight cross-section, juxtaposed each other, so that final rope has no inner cavities having a geometric origin, as those due to the placing side by side circular cross-section elements.

However, the above solution is characterized by a technical limitation in the solution for tightening bands, so that all the described embodiments are based on the possibility of activating an inner friction level sufficient to support the whole outer load.

Further, Japanese utility model JP S54 45076 U describes a rope obtained starting from a band wound on the same and sewed at the ends and along its body by suitable seams, creating two hooking eyelets. However, said solution has a low mechanical reliability, and it is in any case not applicable for metallic bands.

It is the object of the present invention that of overcoming the structural hooking limitation suggesting a completely new general arrangement of the invention that can maximize the structural efficiency on the basis of a new realization concept of the rope that reduce at the minimum the hooking stresses.

It is the object of the present invention a rope comprised of a band, mainly having a linear extension with flat faces and a substantially flattened straight cross-section, said rope comprising two pins spaced each other along an axis passing between said pins, said band being wound up on said two pins, in such a way to continuously form a plurality of overlapped coils, wherein the plurality of band portions extending parallel to said axis passing between a pin and the other realize two arms and a bending point in correspondence of each pin, said rope comprising at least one clamping device near at least one of said bending points, able to direct, from outside toward inside said rope, each of said arms in at least one counter-bending point in order to block the mutual sliding of said plurality of band portions and the rotation of said rope around at least one of said pins, as a result of a loss of balance of the load applied on said rope.

Preferably, according to the invention, said rope can comprise a clamping device near each of said bending points.

Still according to the invention, said at least one clamping device can comprise retaining means of said plurality of coils, and thrust means, able to direct, from outside toward the inside of said rope, each of said arms in said at least one counter-bending point.

Always according to the invention, said at least one clamping device can comprise a hooking element coincident with one of said pins, on which it is wound up said band, two side plates, each having at least one hole, at least one thrust element apt to be inserted in said at least one hole of said side plates, being arranged externally to said arms of said rope, in such a way to realize said at least one counter-bending point on each arm of said rope.

Particularly, according to the invention, said clamping device can comprise two thrust elements inserted in said at least one hole of each of said side plates, each thrust element being arranged externally with respect to a relevant arm of said rope.

More particularly, according to the invention, each one of said thrust elements can have a cross-section shaped as an arc of a cylinder, having an external radius so as to be inserted in said at least one hole of each of said plates in a symmetrical way in relation to said axis, and said thrust elements can realize two counter-bending points on each of said arms.

Further, according to the invention, said clamping device further comprises two fastening elements, each one coupled to said pin externally to a respective plate, in correspondence of at least one hole, in order to block said clamping device.

Furthermore, according to the invention, each plate can comprise two holes, said hole being able to house said pin, and said two thrust elements being inserted through said hole of each of said plates, and in that the centres of said holes are along said axis passing between said first and said second pin on which said band is wound up.

Further, each of said two side plates of said clamping device can comprise two holes among said at least one hole, symmetrically arranged in relation to said axis, and in that two thrust elements are provided, each one being inserted in a respective hole of said plates, being placed externally to said arms of said rope.

Preferably, said plates and said pin can be one single integral element.

Still according to the invention, said at least one thrust element can have a “C” shaped cross-section partially wrapping said rope, having two free ends, said thrust element realizing, in correspondence of said free ends, a counter-bending point on each arm of said rope.

Alternatively, according to the invention, said retaining means can comprise two side plates each one having two shaped housings, symmetrical each other with respect to said axis, in such a way that, when said plates are coupled, said shaped housings direct a respective arm of said rope in said at least one counter-bending point.

Particularly, according to the invention, each of said plates can have a further housing arranged along said axis, and in that said retaining means further comprise a fastening element able to be inserted in said further housings when said plates are coupled to each other.

More particularly, said plates can be one single integral element.

Preferably, according to the invention, said clamping device can comprise a hooking element coincident with one of said pins and said pin can have a hole apt to house a connection element provided with ball joint.

Always according to the invention, said clamping device comprises one hooking element coincident with one of said pins and in said hooking can have a radial wedge-shaped protrusion, apt to be placed between said arms of said rope along said axis in order to avoid the sliding between said arms, preventing the rotation of said pin around its axis.

Finally, according to the invention, at least one of said faces of said band can be rendered sticky.

The invention will be descrive, for illustrative, but not limitative, purpose, with particular reference to the drawings of the enclosed figures, wherein:

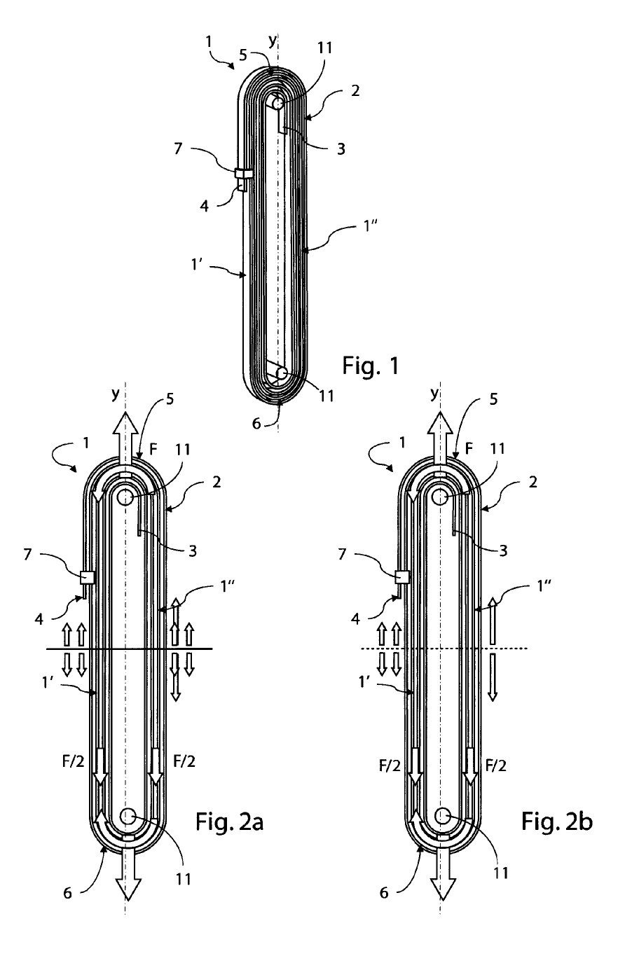

FIG. 1 shows a perspective view of the realization of the rope according to the invention;

FIG. 2a shows a front schematic view of force distribution of rope of FIG. 1;

FIG. 2b shows a front schematic view of force distribution of rope of FIG. 1 in case of unbalanced breaking of one or more portions of said rope;

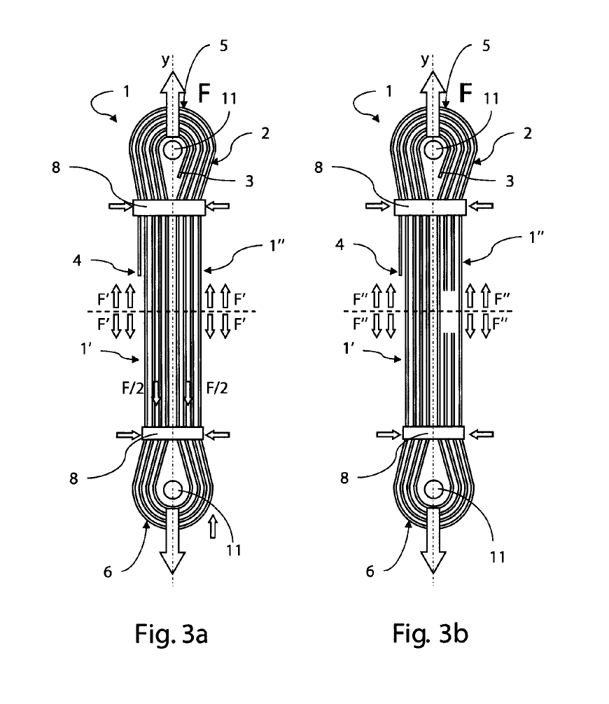

FIG. 3a shows a front schematic view of force distribution of rope of FIG. 1 in its final configuration, comprising a clamping device in correspondence of both its ends;

FIG. 3b shows a front schematic view of force distribution of rope of FIG. 3a in case on unbalanced breaking of one or more portions of said rope;

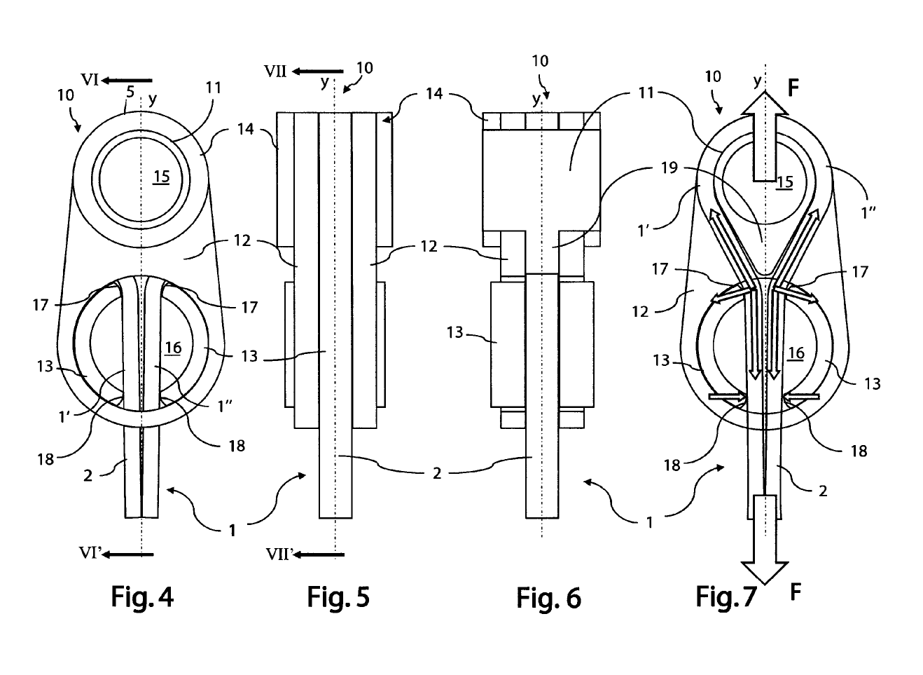

FIG. 4 shows a front view of the preferred embodiment of clamping device of the rope according to the invention;

FIG. 5 shows a lateral view of the clamping device of FIG. 4;

FIG. 6 shows a lateral section view of device of FIG. 4 taken along line VI-VI′;

FIG. 7 shows a front section view of device of FIG. 4 taken along line VII-VII′,

FIG. 8 shows an axonometric view of the rope of FIG. 1 comprising a device according to FIG. 4 for each end, one of which is represented in an explode view;

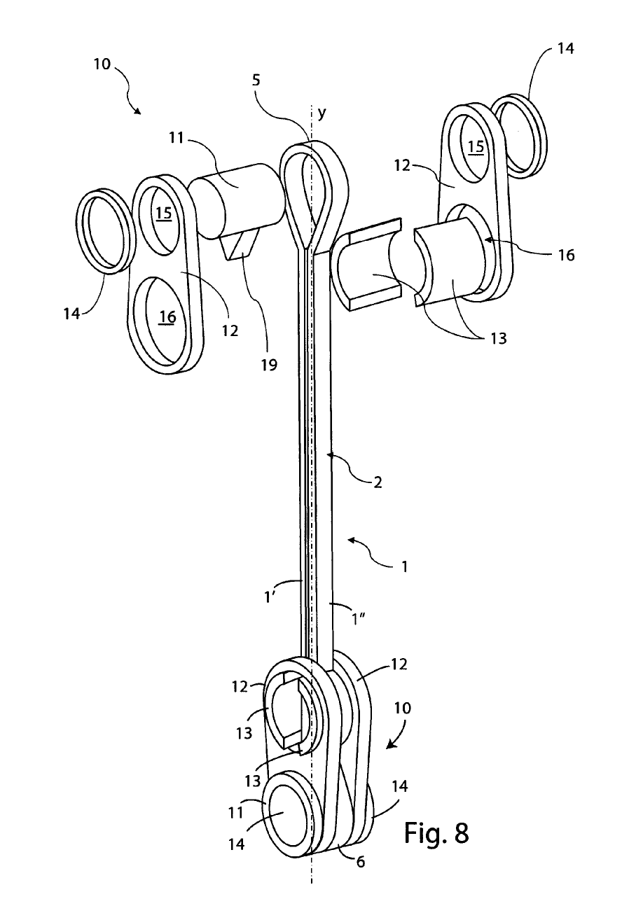

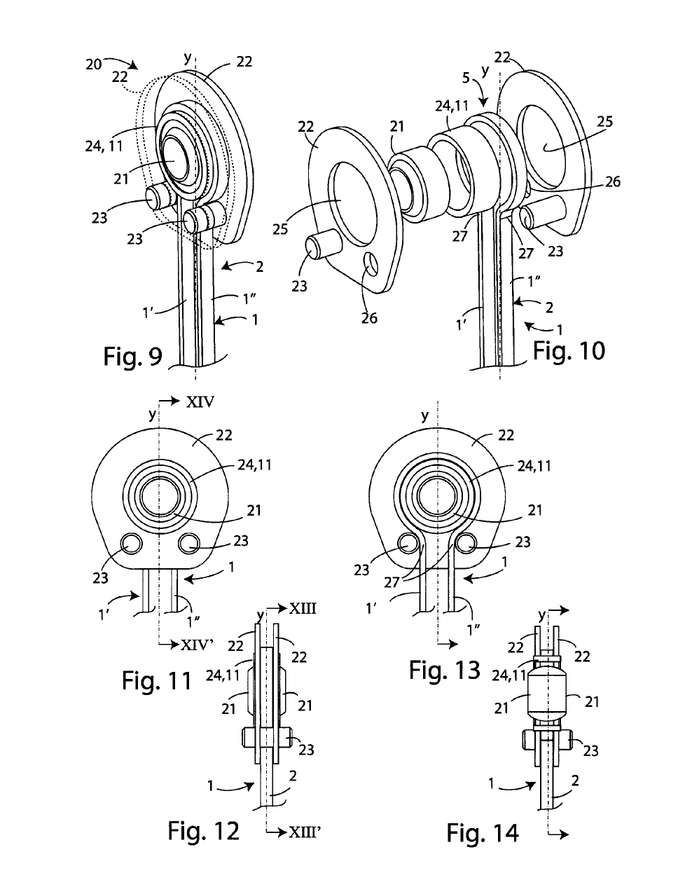

FIG. 9 shows an axonometric view of a second embodiment of the clamping device of the rope according to the invention;

FIG. 10 shows an exploded axonometric view of the clamping device of FIG. 9;

FIG. 11 shows a front perspective view of the clamping device of FIG. 9;

FIG. 12 shows a lateral perspective view of the clamping device of FIG. 9;

FIG. 13 shows a front cross-section of clamping device of FIG. 9 taken along line XIII-XIII′ of FIG. 12;

FIG. 14 shows a side cross-section of clamping device of FIG. 9 taken along line XIV-XIV′ of FIG. 11;

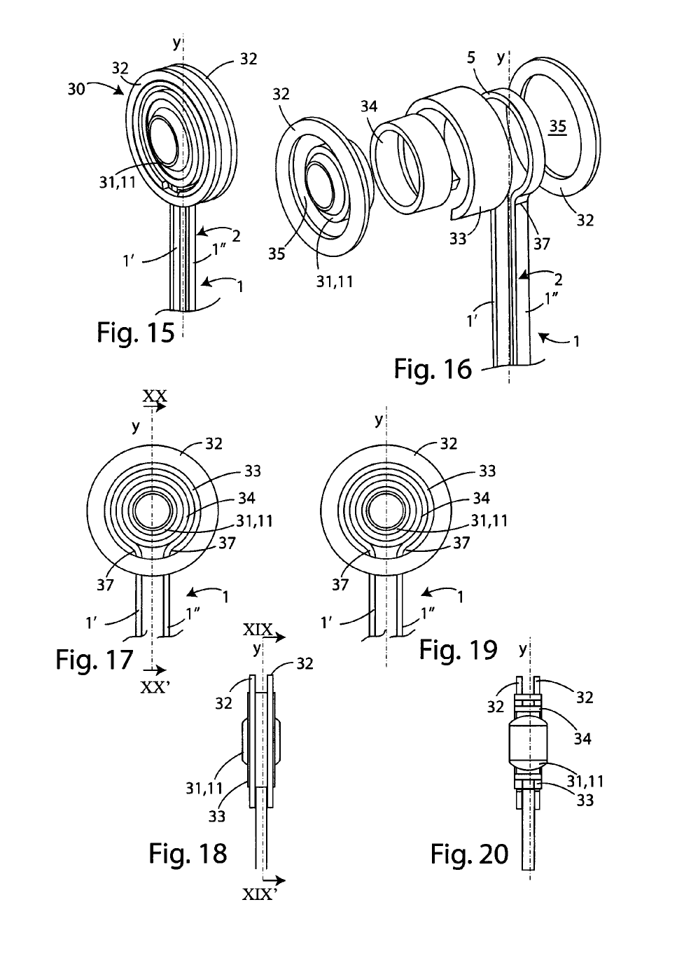

FIG. 15 shows an axonometric view of a third embodiment of the clamping device of the rope according to the invention;

FIG. 16 shows an exploded axonometric view of the clamping device of FIG. 15;

FIG. 17 shows a front perspective view of the clamping device of FIG. 15;

FIG. 18 shows a lateral perspective view of the clamping device of FIG. 15;

FIG. 19 shows a front section of clamping device of FIG. 15 taken along line XIX-XIX′ of FIG. 18;

FIG. 20 shows a lateral section view of the clamping device of FIG. 15 taken along line XX-XX′ of FIG. 17;

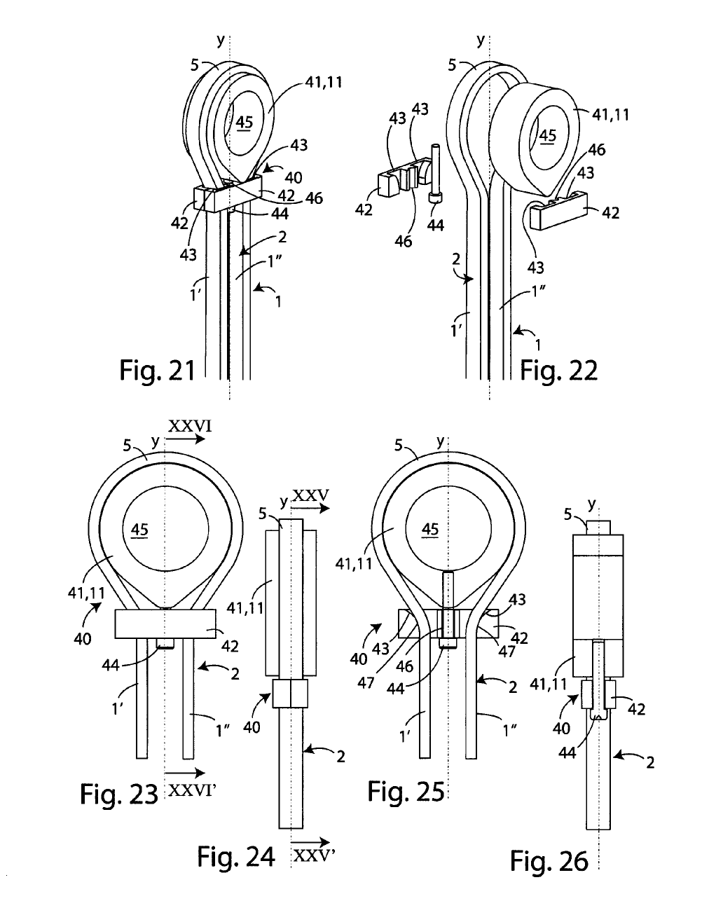

FIG. 21 shows an axonometric view of a fourth embodiment of the clamping device of the rope according to the invention;

FIG. 22 shows an exploded axonometric view of the clamping device of FIG. 21;

FIG. 23 shows a front perspective view of the clamping device of FIG. 21;

FIG. 24 shows a lateral perspective view of the clamping device of FIG. 21;

FIG. 25 shows a front section of clamping device of FIG. 15 taken along line XXV-XXV′ of FIG. 24;

FIG. 26 shows a lateral section view of the clamping device of FIG. 21 taken along line XXVI-XXVI′ of FIG. 23;

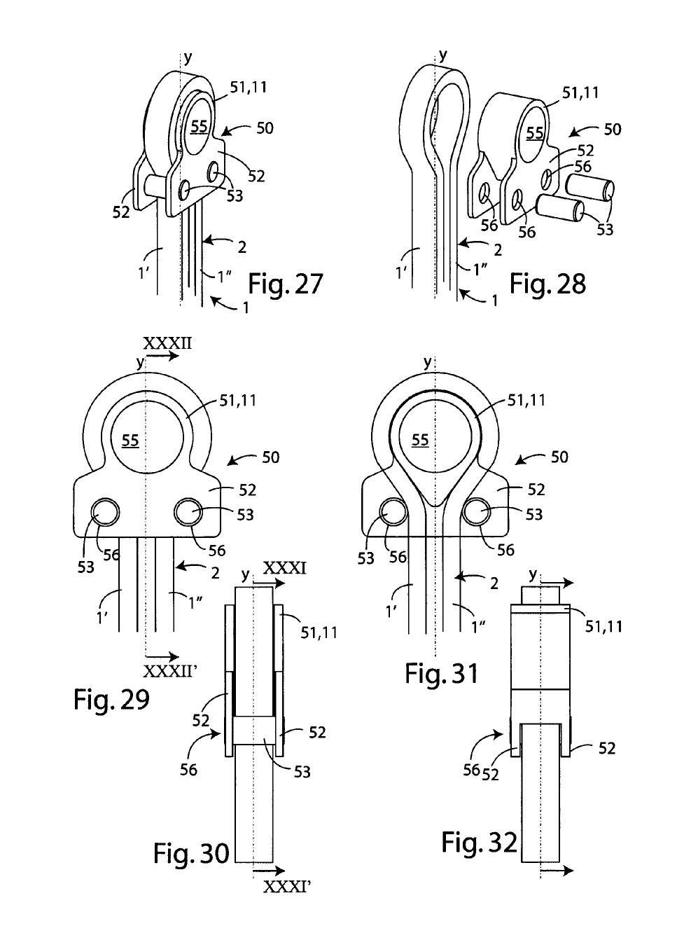

FIG. 27 shows an axonometric view of a fifth embodiment of the clamping device of the rope according to the invention;

FIG. 28 shows an exploded axonometric view of the clamping device of FIG. 27;

FIG. 29 shows a front perspective view of the clamping device of FIG. 27;

FIG. 30 shows a lateral perspective view of the clamping device of FIG. 27;

FIG. 31 shows a front section of clamping device of FIG. 27 taken along line XXXI-XXXI′ of FIG. 30;

FIG. 32 shows a lateral section view of the clamping device of FIG. 27 taken along line XXXII-XXXII′ of FIG. 29.

Making reference to FIGS. 1-3, it is observed the rope according to the invention, according to its primary representation, indicated by reference number 1. Said rope 1 comprises two pins 11, spaced each other along an axis y passing between said pins 11, a band 2, having a rectangular cross-section, with a first end 3 and a second end 4, wound or turned many times about said two pins, corresponding to two hooking elements 11 of the rope to a structure (not shown), realising a plurality of continuous juxtaposed turns realising a hank, so that band portions 2 extending parallel with respect to axis y, extending between a pin 11 and the other 11, realize two arms 1′, 1″ and a folding point 5, 6 in correspondence of each pin 11.

Said rope 1 according to the invention is preferably comprised of metallic material, particularly steel.

By band it is meant an element having a prevailing rectilinear or linear extension with flat faces, a quadrangular section, particularly a flat or plane rectangular section, or a substantially flattened section, uniform all along its length so as to be considered a band.

Said first end 3 of the band 2 is free and is provided inside with respect to said hank, and said second end 4 of the band 2 is provided outside with respect to said hank, and can be blocked, limiting to the coupling of the band 2 very close, by a blocking element 7.

Every inner turn of the rope 1 hank, when subjected to a load, is thus blocked by friction activated in two end bending points, in correspondence of said two hooking elements 11.

Thus, rope 1, when loaded, is self-constrained on all turns but the last portion of the band 2, that is blocked by said blocking element 7, thus obtaining an equivalent distribution of the forces F between two arms 1′ and 1″ of the rope 1 (as shown in FIG. 2a).

However, treating pins 11 as pulleys, in case of theoretical breaking of a portion of the band 2 and in disadvantageous, but possible, hypothesis that said breaking is unbalanced, thus interesting only one arm 1′ or 1″ (FIG. 2b), it would bring to an overloading proportional to stress only in “reduced” arm, being its necessary balancing outer force F always on both arms 1′ and 1″, thus involving a bigger lengthening and therefore sliding of rope 1 by rotation about pins 11. Said arrangement could determine a relevant criticism quickly jeopardizing reliability of rope due to a string increase of stress on the residual section of the “reduced” arm.

Thus, to obtain the same mechanical reliability of conventional ropes, it is necessary that, due to the breakage of one or more sections, it is obtained the same uniform distribution of the load increase on all residual sections or band portions.

Therefore to complete the invention, it has been developed a solution to fully block sliding by rotation about pins/pulleys 11 according to the scheme of FIGS. 3a and 3b, wherein two clamping devices 8 for said arms 1′, 1″ are provided, in correspondence of both bending points 5 and 6 of said rope 1, in order to unlock sliding of band 2 in correspondence of bending points 5 and 6 of the rope 1, thus realising two counter bending points in correspondence of which it is activated blocking of sliding by friction, particularly of outer windings, in this case inside, when said rope 1 is subjected to loading, particularly when arms 1′, 1″ of said rope 1 are subjected to loading.

Particularly, said clamping elements 8, aimed at realising counter bending points, are close to the final portion of bending points 5, 6 and in correspondence of arms 1′, 1″ of the rope 1.

Thus, it is clear that, in case of breaking of one or more portions of band 2 and consequent unbalancing of rope 1 load, outer force, in absence of sliding/rotation around pins 11, are uniformly distributed in remaining sections of band portions 2 (as shown in FIG. 3b).

A preferred embodiment of clamping device according to the invention is shown in FIGS. 4-8 and indicated by reference number 10.

Said clamping device 10 comprises a element 11 for hooking to the structure (not shown), coincident with said pin 11 on which said rope 1 band 2 is wound, thus realising a hank winding with two arms 1′, 1″ and two bending points 5 and 6, two positioning and guiding plates 12 of said band 2 on said hooking element 11, provided outside and laterally with respect to said band 2, so as to contain said plurality of turns, each one comprising a first hole 15 and a second hole 16, between said two first holes 15 of said plates 12 being inserted said hooking element 11. Said clamping device 10 further comprises two thrust elements 13, symmetric with respect to the axis y extending between the two pins 11 of the rope 1. Said thrust elements 12 can be inserted within said second holes 16 of said plates 12, laterally with respect to said arms 1′, 1″ of said rope 1.

Finally, said clamping element 10 comprises two fixing elements 14 that can be coupled with said hooking element 11, outside said plates 12, in correspondence of said first hole 15, in order to block said clamping device 10.

Said clamping device 10, by said thrust elements 13, realizes two counter-bending points 17 and 18 on each arm 1′ and 1″ of the same rope 1. A first counter-bending point 17 is close to the end of the bending point 5 or 6 of rope 1, causing its straightening, and the second counter-bending point 18 acts on arms 1′, 1″ of the rope 1, in order to obtain a tightening action on the same.

Particularly, said first 15 and second 14 holes have a circular shape, the centres of which are provided along axis y passing through pins 11 of rope 1. Said hooking element 11 has a cylindrical body, the section of which has an outer diameter apt to be inserted within said first hole 15 of said plate 12.

Further, said hooking element 11 can advantageously, but not necessarily, have a wedge-shaped projection 19, having a symmetry axis coaxial with respect to the axis y passing between pins 11 and thus with centre of circumference of the section of said cylindrical body. Said projection 19 aims at preventing, as a further protection, sliding between two arms 1′, 1″ of said rope 1 preventing rotation of the hooking element 11.

Said thrust elements 13 preferably have a cylinder arc section, with the ray substantially equivalent to the ray of said second hole 16 of said plates 12. Said thrust elements 13 are thus symmetrically inserted in said second hole 13. Therefore, each thrust element 13 pushes on each arm 1′ or 1″ of said rope 1, in correspondence of the two counter-bending points 17, 18, preventing a possible sliding of rope 1 caused by an asymmetry or unbalancing of the two arms 1′ and 1″.

Thus, it is clear that, in case of breaking of one or more band portions 2, being it prevented relative sliding, two arms 1′, 1″ are obliged to the same lengthening and thus every single portion of the band 2 is subjected to the same load, i.e. force F applied on said hooking element 11 is uniformly redistributed in remaining band 2 sections.

Rope-clamping device system according to the invention, when loaded, is self-tightening.

A further advantage of the invention is that of being agile and manageable, since it can be easily realised, as well as economic.

In preferred, but not exclusive, embodiments, said band 2 can have a rectangular cross-section.

Thickness of the band is advantageously thin, in the order of millimetre, since it permits a double advantage: it is possible turning over it (rope forming) due to the reduced flexional rigidity; and obtaining high and uniform mechanical features as a consequence of the productive process by cold drawing.

In further embodiments, band 2 can have at least a face with sticky or adhesive surface, so as to exaggerate sealing of adjacent band portions when rope is subjected to a load, obtaining a greater durability.

Particularly, a resin can be used as glue, to be hardened when the rope is realised and used.

Further, the advantage of simplifying coupling between rope 1 and structure (not shown) by clamping device according to the invention, particularly by hooking element, permitting eliminating fusion, particularly bulky and expensive constructive particulars, expensive technologies and difficult control.

Hooking element can advantageously provide a ball joint, housed within hollow body of hooking element, as it is shown in the embodiments described in the following.

A second embodiment of the clamping device according to the invention, indicated by reference number 20, is shown in FIGS. 9-14.

Said clamping device 20 provides a structure (not shown) hooking element, comprising a first body 21, conveniently, but not necessarily, a ball joint for hooking to the structure, and a second body 24, wounding said first body 21, coincident with pin 11 which realizes the bending point 5 or 6 about which said band 2 of said rope 1 realised by a hank winding two arms 1′ and 1″.

Said clamping device 20 further comprises two positioning and guide plates 22 for said band 2 on said second body 24 of the hooking element 21, so as to contain a plurality of turns, provided outside and laterally with respect to said band 2, each one comprising a first hole 25 and two second holes 26, that advantageously, but not necessarily, are circular, symmetric with respect to the axis y of the rope 1, between said first holes 25 of said plates 22, inserting between said second body 24 of the hooking element 21, and two thrust elements 23, each one able to enter within said second holes 26 of said plates 22.

Said clamping device 20 realises, by said thrust elements 23, a counter-bending point 27 on each arm 1′, 1″ of the rope 1, close to the end of the counter-bending point 5 or 6 of the rope 1, thus causing its straightening.

Particularly, said first 25 and second 26 holes have a circular shape, the centres of which are symmetrically provided with respect to axis y passing between pins 11 of rope 1. Said second body 24 of said hooking element has a hollow cylindrical body, the section of which has the outer diameter apt to enter within said first hole 25 of said plate 22 and inner diameter of hollow body has such dimensions to house the first body 21 of the hooking element.

Further, said second body 24 of the hooking element can advantageously, but not necessarily, have a wedge-shaped projection, having the symmetry axis coaxial with respect to the axis y passing through pins 11 of rope 1 in order to prevent, as a further protection, sliding between two arms 1′, 1″ of said rope 1 preventing rotation of said second body 24 about said pin 11 coupling with the structure (not shown).

Said thrust elements 23 preferably are two cylindrical pins having such a section to have the outer radius substantially equivalent to the radius of the relevant second hole 26 of said plates 22, so as to enter within the same. Therefore, each thrust element 23 pushes outward on each arm 1′, 1″ of said rope 1, in correspondence of the relevant counter-bending point 27, thus preventing a possible sliding of rope 1 caused by a possible asymmetry or unbalancing of the two arms 1′ and 1″.

A third embodiment of the clamping device according to the invention, indicated by reference number 30, is shown in FIGS. 15-20.

Said clamping device 30 is difference with respect to the one described with reference to FIGS. 9-14 since, besides providing an element for hooking to the structure (not shown), comprising a first body 31, conveniently, but not necessarily, a ball joint, for hooking to the structure, and a second body 34, wounding said first body 31, coincident with pin 11 about which said band 2 of said rope 1 realised by a hank winding with two arms 1′, 1″ and a bending point 5 for each pin, two positioning and guiding plates 32 for said band 2 on said second body of the hooking element, so as to contain said plurality of turns, provided outside and laterally with respect to said band 2, each one of them only having a single hole 35. Further, said clamping device 30 according to the third embodiment has a single thrust element 33, apt to enter within said first holes 35 of said plates 22 and, at the same time, partially winds said rope 1 in correspondence of said bending point 5.

Particularly, said thrust element 33 has a “C” shaped cross-section with two free ends, so that said clamping device 30, by said thrust element 33, realises, in correspondence of the free ends, a counter-bending point 37 for each arm 1′ and 1″ of the rope 1, close to the end of the bending point 5 or 6 of the rope 1, causing its straightening, preventing a possible sliding of rope 1 caused by an asymmetry or unbalancing of the two arms 1′ and 1″.

A fourth embodiment of the clamping device according to the invention, indicated by reference number 40, is shown in FIGS. 21-26.

Said clamping device 40 further comprises an element for hooking to the structure 41, coincident with one of the two pins 11 about which said band 2 of said rope 1 realised by a hank winding with two arms 1′, 1″ is wound, and two bending points 5, 6, two positioning and guiding plates 42 for said rope 1, so as to contain said plurality of turns, each plate 42 comprising two shaped housings 43, through which said arms 1′ and 1″ are passed when said plates 42 are coupled each other.

Said clamping device 40 further comprises a fixing element 44, apt to fix said coupled plates to the hooking element 41.

Said fixing element 44 can be a pin that can pass through a further through housing 46, obtained in each plate 42 and provided along said axis y, and coupling with said hooking element 41.

In this particular embodiment, said shaped housings 43 of said plates 42 are symmetric with respect to axis y passing between pins 11 about which the rope is wound and have a circumference arc shape so as to push on each arm 1′ or 1″ creating a counter-bending point 47, when said rope 1 is subjected to a load, thus determining its straightening in case of asymmetry or unbalancing of the load applied on said rope 1.

Particularly, said two ropes 42 can realise a single block element, comprising two shaped through holes 43 through which said arms 1′ and 1″ are respectively passed and a central through hole 46 to house said fixing element 44.

A fifth embodiment of the clamping device according to the invention, indicated by reference number 50, is shown in FIGS. 27-32.

Said clamping device 50 is an improvement of the second embodiment shown in FIG. 9-14, comprising hooking element 51 and two lateral plates 52 in a single block, so that first hole 55 of lateral plates 52 is coincident with the hole of the hooking element 51 for housing the hooking element 51 to the structure, such as a ball joint.

Further plates 52 have two holes 56 symmetric with respect to the axis y passing through pins 11 about which the band is wound, through which two thrust elements 53 pass, so that when said rope 1 is subjected to a load, thrust elements 53 push from outside on each arm 1′ and 1″ of the rope, creating a respective counter-bending point 57 straightening arms and preventing rotation of the rope 1 with respect to the pin 11 or hooking element 51 in case of asymmetry or unbalancing of the load applied to said rope 1.

All the embodiments of the clamping device of the rope according to the invention described in the above have the same advantages of the preferred embodiment described in the above.

Rope clamping device of every embodiment can be applied to the rope according to the invention in correspondence of only one or each bending point, without departing from the scope of the present invention.

Preferred embodiments of the present invention have been described in the above and variations have been suggested, but it is to be understood that those skilled in the art can introduce modifications and variations without departing from the relevant scope, as defined in the enclosed claims.

1. Rope comprised of a band, mainly having a linear extension with flat faces and a substantially flattened straight cross-section, the rope comprising two pins spaced each other along an axis passing between the pins, the band being wound up on the two pins, in such a way to continuously form a plurality of overlapped coils, wherein the plurality of band portions extending parallel to the axis passing between a pin and the other realize two arms and a bending point in correspondence of each pin, the rope comprising at least one clamping device near at least one of the bending points, able to direct, from outside toward inside the rope, each of the arms in at least one counter-bending point in order to block the mutual sliding of the plurality of band portions and the rotation of the rope around at least one of the pins, as a result of a loss of balance of the load applied on the rope.

2. Rope according to claim 1, characterized in comprising a clamping device near each of the bending points.

3. Rope according to claim 1, characterized in that the at least one clamping device comprises retaining means of the plurality of coils, and thrust means, able to direct, from outside toward the inside of the rope, each of the arms in the at least one counter-bending point.

4. Rope according to claim 3, characterized in that the at least one clamping device comprises a hooking element coincident one of the pins, on which it is wound up the band, two side plates, each having at least one hole, at least one thrust element apt to be inserted in the at least one hole of the side plates, being arranged externally to the arms of the rope, in such a way to realize the at least one counter-bending point on each arm of the rope.

5. Rope according to claim 4, characterized in that the clamping device comprises two thrust elements inserted in the at least one hole of each of the side plates, each thrust element being arranged externally with respect to a relevant arm of the rope.

6. Rope according to claim 5, characterized in that each one of the thrust elements has a cross-section shaped as an arc of a cylinder, having an external radius so as to be inserted in the at least one hole of each of the plates in a symmetrical way in relation to the axis, and in that the thrust elements realize two counter-bending points on each of the arms.

7. Rope according to claim 4, characterized in that the clamping device further comprises two fastening elements, each one coupled to the pin externally to a respective plate, in correspondence of at least one hole, in order to block the clamping device.

8. Rope according to claim 5, characterized in that each plate comprises two holes, the hole being able to house the pin, and the two thrust elements being inserted through the hole of each of the plates, and in that the centres of the holes are along the axis passing between the first and the second pin on which the band is wound up.

9. Rope according to claim 4, characterized in that each of the two side plates of the clamping device comprises two holes among the at least one hole, symmetrically arranged in relation to the axis, and in that two thrust elements are provided, each one being inserted in a respective hole of the plates, being placed externally to the arms of the rope.

10. Rope according to claim 9, characterized in that the plates and the pin are one single integral element.

11. Rope according to claim 4, characterized in that the at least one thrust element has a “C” shaped cross-section partially wrapping the rope, having two free ends, the thrust element realizing, in correspondence of the free ends, a counter-bending point on each arm of the rope.

12. Rope according to claim 3, characterized in that the retaining means comprise two side plates each one having two shaped housings, symmetrical each other with respect to the axis, in such a way that, when the plates are coupled, the shaped housings direct a respective arm of the rope in the at least one counter-bending point.

13. Rope according to claim 12, characterized in that each of the plates has a further housing arranged along the axis, and in that the retaining means further comprise a fastening element able to be inserted in the further housings when the plates are coupled to each other.

14. Rope according to claim 12, characterized in that the plates are one single integral element.

15. Rope according to claim 1, characterized in that the clamping device comprises a hooking element coincident with one of the pins and in that the pin has a hole apt to house a connection element provided with ball joint.

16. Rope according to claim 1, characterized in that the clamping device comprises one hooking element coincident with one of the pins and in that the pin has a radial wedge-shaped protrusion, apt to be placed between the arms of the rope along the axis in order to avoid the sliding between the arms, preventing the rotation of the pin around its axis.

17. Rope according to claim 1, characterized in that at least one of the faces of the band is rendered sticky.
